(19) United States
(12) Patent Application Publication
(10) Pub. No.: US 2012/0330777 A1
(43) Pub. Date: Dec. 27, 2012

(54) METHOD AND APPARATUS FOR PROVIDING RECOMMENDATIONS BASED ON LOCALLY GENERATED MODELS

(75) Inventors: Sailesh Kumar Sathish, Tampere (FI); Jari Pekka Hämäläinen, Kangasala As (FI); Olivier Dousse, Lausanne (CH); Juha Kalevi Laurila, St-Legier (CH)

(73) Assignee: Nokia Corporation, Espoo (FI)

(21) Appl. No.: 13/169,813

(22) Filed: Jun. 27, 2011

(51) Int. Cl. G06Q 30/02

(52) U.S. Cl. 705/26.7

(57) ABSTRACT

An approach is provided for recommendations based on locally generated models. The model platform causes, at least in part, a transfer of at least one user model from a device to a recommendation service, wherein the at least one user model is generated on the device. Next, the model platform determines to associate the at least one user model with user profile information. Then, the model platform processes and/or facilitates a processing of the at least one user model, the user profile information, or a combination thereof to generate at least one recommendation.

### BACKGROUND

Service providers and device manufacturers (e.g., wireless, cellular, etc.) are continually challenged to deliver value and convenience to consumers by, for example, providing compelling network services. One area of interest has been providing personalized user experiences, for instance, to mobile device users. For example, personalization, recommendation, and target advertising are some key elements of a successful service for mobile device users. However, conventional approaches typically experience issues such as cold start, lack of ratings, etc., that may prevent the creation of personalized service for users. A new user who tries a service, for instance, for the first time generally receives a non-personalized experience because the service must initially learn data from the user. Even if the user is not new to the service, the service may require much more data than already provided (e.g., manually entered data, data automatically configured through user interactions, etc.), in order to do a meaningful job. Accordingly, these conventional approaches are usually limited in scope and often may not provide users with the desired experience.

### SOME EXAMPLE EMBODIMENTS

Therefore, there is a need for an approach for providing recommendations based on locally generated models.

According to one embodiment, a method comprises causing, at least in part, a transfer of at least one user model from a device to a recommendation service, wherein the at least one user model is generated on the device. The method also comprises determining to associate the at least one user model with user profile information. The method further comprises processing and/or facilitating a processing of the at least one user model, the user profile information, or a combination thereof to generate at least one recommendation.

According to another embodiment, an apparatus comprises at least one processor, and at least one memory including computer program code for one or more computer programs, the at least one memory and the computer program code configured to, with the at least one processor, cause, at least in part, the apparatus to transfer at least one user model from a device to a recommendation service, wherein the at least one user model is generated on the device. The apparatus is also caused to determine to associate the at least one user model with user profile information. The apparatus is further caused to process and/or facilitate a processing of the at least one user model, the user profile information, or a combination thereof to generate at least one recommendation.

According to another embodiment, a computer-readable storage medium carries one or more sequences of one or more instructions which, when executed by one or more processors, cause, at least in part, an apparatus to transfer at least one user model from a device to a recommendation service, wherein the at least one user model is generated on the device. The apparatus is also caused to determine to associate the at least one user model with user profile information. The apparatus is further caused to process and/or facilitate a processing of the at least one user model, the user profile information, or a combination thereof to generate at least one recommendation.

According to another embodiment, an apparatus comprises means for causing, at least in part, a transfer of at least one user model from a device to a recommendation service, wherein the at least one user model is generated on the device. The apparatus also comprises means for determining to associate the at least one user model, the at least one item model, or a combination thereof with an account of at least one user of the device. The apparatus further comprises means for processing and/or facilitating a processing of the at least one user model, the user profile information, or a combination thereof to generate at least one recommendation.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing recommendations based on locally generated models, according to one embodiment;

FIG. 2 is a diagram of the components of a model platform, according to one embodiment;

FIG. 3 is a flowchart of a process for providing recommendations based on locally generated models, according to one embodiment;

FIG. 4 is a flowchart of a process for generating recommendations using other user models, according to one embodiment;

FIG. 5 is a flowchart of a process for updating a user model, according to one embodiment;

FIGS. 6A-6D are diagrams of user interfaces utilized in the processes of FIG. 3, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing recommendations based on locally generated models are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

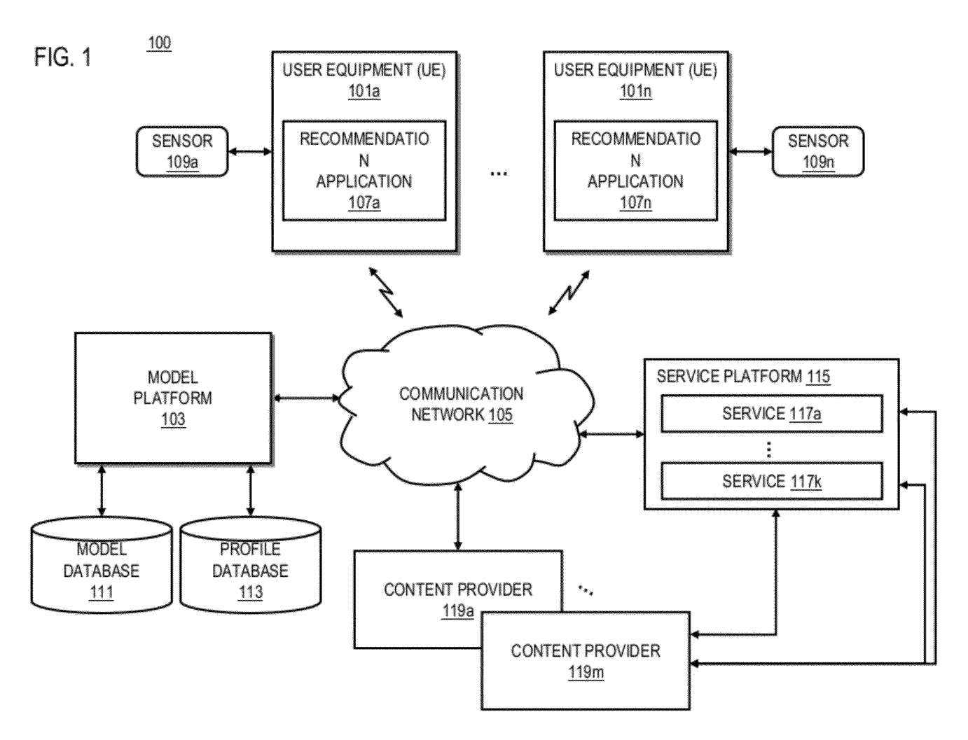

FIG. 1 is a diagram of a system capable of providing recommendations based on locally generated models, according to one embodiment. As discussed, the personalized user experience desired is often not attained for a number of reasons. Although common approaches, which include online collaborative filtering, do offer some level of personalization, these approaches are unable to provide the desired user experience in a number of circumstances (e.g., cold start, lack of ratings, etc.). As explained, these circumstance can occur even when a user has used a particular service in the past, for instance, due to insufficient data. Moreover, in addition to such issues, these approaches are generally limited in scope in other areas. By way of example, recommendation services often can only provide a user with personalized, recommendations originally intended for the user. Thus, for instance, a user wishing to purchase a birthday gift for an acquaintance may still have to go through the trouble of taking guesses and questioning other people as to the acquaintance's desired items. Further, users looking to change their lifestyle or to acquire an aspiration lifestyle must also go through the troubled tasks of research, trial, and error.

To address this problem, a system 100 of FIG. 1 introduces the capability to utilize models from a device to improve the performance of a recommendation system (or service). Specifically, the system 100 may generate recommendations based on a user model from the device. By way of example, the system 100 may generate the recommendations by processing the user model along with user profile information. The user model may, for instance, include information about the user's behavior, preferences, or any other information associated with the user. Other information, for instance, may include collected data corresponding to various items related to the user or the device. The items may represent various features or settings, such as user interface modes, points of interest (POIs), consumer products or services, etc. Moreover, the user model may be locally generated on the device, for instance, based on user interaction data, ratings data, context data, or other information relating to one or more items, the user of the device, and/or one or more other users. The user models may then be transferred from the device to a recommendation service and associated with user profile information so that the user model and the user profile information may be utilized to generate recommendations, for instance, for the user. Alternatively, or additionally, the user model may be shared with other users. For example, the user may share the user model via peer-to-peer, using social networking outlets, etc., to enable others to see recommendations (e.g., generated based on the shared model) originally intended for the user. The user may, for instance, also receive recommendations originally intended for other users that are generated based on shared models of the other users.

In one sample use case, a user visits a particular city for the first time. As such, the user has never been to any place in this city prior to this initial visit. It is likely, particularly if the user's own hometown is a small city, that very few users in this particular city have visited the user's hometown. Thus, a typical recommendation service may not be able to relate the user to any place in town. However, using the user model transferred from the user's device, the system 100 may identify other users in the city with similar lifestyles (e.g., by comparing the user model of the user against other user models of other users). Accordingly, the system 100 may use the user models associated with the identified users having similar lifestyles as the user as a basis for generating appropriate recommendations for the user (e.g., providing travelling tips, POIs to visit, events in the city, etc.). In this way, the recommendations are not necessarily based on content analysis of what was recommended, but instead based on usage history and user behavior with respect to particular circumstances (e.g., similar lifestyles, interactions, etc.).

In another scenario, a user may be accessing a new service, such as a music service. In this case, the user may already be a registered user of an online portal (e.g., the recommendation service) offering the music service. As such, the user may have a history with the online portal (e.g., user interface preferences, payment histories, other content ratings, etc.), but no history with the particular music service. Even assuming, however, that the user also has no music-related history with the online portal, the online portal may still be able to personalize the music service offered to the user. As with the previous example, the system 100 may identify other users who, for instance, share characteristics with the user (e.g., lifestyles, tastes, etc.). Thus, the system 100 may determine that the user models associated with the identified users have characteristics that are substantially similar to the user model associated with the user. Consequently, the user models associated with the identified users may be utilized to further personalize the music service for the user. By way of example, the recommended content may be based on the user models associated with the identified users while the presented user interface, content sampling methods, payment methods, etc., may be based on the user model of the user.

More specifically, the system 100 may cause, at least in part, a transfer of at least one user model from a device to a recommendation service, wherein the at least one user model is generated on the device. The at least one user model may, for instance, include at least one user profile vector, at least one item profile vector, etc. Thus, the at least one user model may have quantitative values. When generating the at least one user model, available data may be quantified to create the user profile vector and the item profile vector. In addition, because the at least one user model is generated on the device, the system 100 preserves privacy in the sense that the behavioral data can be utilized without necessarily transmitting that particular data to any external device or service. Rather, the behavioral data may be processed locally on the device, for instance, to generate user profile vectors with latent variables to prevent discovery of confidential and/or personal information through reverse-engineering of the user profile vectors. Similarly, such process may be applied to the generation of the item profile vectors. The system 100 may then determine to associate the at least one user model with user profile information. The user profile information may, for instance, include rating information or any information that might indicate the user's preference toward a particular item (e.g., giving an explicit thumbs-up rating, viewing the item, buying the item, other interactions with the item, presence at a place listed in the item, etc.) along with other information, such as contact information (e.g., address, phone, email, fax, etc.), payment information, etc. The system 100 may further process and/or facilitate a processing of the at least one user model and/or the user profile information to generate at least one recommendation.

As shown in FIG. 1, the system 100 comprises a user equipment (UE) 101 (or UEs 101a-101n) having connectivity to a model platform 103 via a communication network 105. The UE 101 may include or have access to a recommendation application 107 (e.g., recommendation applications 107a-107n) to enable the UE 101 to interact with, for instance, the model platform 103 to transfer user models, send updated models, receive recommendations, select preferences, etc. The UE 101 may further include or have access to a sensor 109 (e.g., sensors 109a-109n) to collect data, for instance, relating to the device and/or the user of the device. The model platform 103 may include or have access to a model database 111 to obtain and store user models, related updates, etc., for generating recommendations. The model platform 103 may also include or have access to a profile database 113 to obtain and store user profile information. Moreover, the model database 111 and/or the profile database 113 may include content associated with the user models and/or the user profile information. Alternatively, or additionally, the model database 111 and/or the profile database 113 may include one or more links to access or obtain content. The content may, for instance, be provided by a service platform 115, one or more services 117 (or services 117a-117k), one or more content providers 119 (or content providers 119a-119m), and/or other services available over the communication network 105. For example, a particular service 117 (e.g., a music or video service) may obtain content (e.g., media content) from a particular content provider 119 to offer the content to the UE 101. Accordingly, the link may be an address or some other identifier that points to a memory or storage location associated with the service platform 115, the services 117, and/or the content providers 119. It is noted that the model platform 103 may be a separate entity of the system 100, a part of the one or more services 117 of the service platform 115, or included within the UE 101 (e.g., as part of the recommendation application 107).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, the model platform 103 may determine that that the at least one user model and one or more other user models have one or more characteristics that are substantially similar. In a further embodiment, the at least one user model is associated with at least one user of the device and the one or more other user models are associated with one or more other users. As previously noted, the model platform 103 may identify other users similar to the at least one user based on the respective user models. In this case, such a match may be found where there are one or more characteristics between the respective user models that are substantially similar. For example, even if the users are in different regions of the world, their location patterns may be summarized in sufficiently abstract ways such that similar patterns occurring in these different regions can still be compared. Based on the determination of substantially similarity, the model platform 103 may the process and/or facilitate a processing of the one or more other user models, wherein the at least one recommendation is further generated based on the processing of the one or more user models.

In another embodiment, the model platform 103 may determine whether at least one user of the device has selected to receive recommendations associated one or more other users. As such, the model platform 103 may therefore generate the at least one recommendation based on the determination of the selection by the at least one user. By way of example, a user may want to live the life of a celebrity. In fact, the user may have a particular celebrity in mind (e.g., Celebrity X). Indeed, Celebrity X may have an associated user model uploaded to a recommendation service. The recommendation service, via the model platform 103, may in turn offer Celebrity X's recommendations as a service for a fee. To live like Celebrity X, the user may, for instance, select an option to receive only recommendations originally intended for Celebrity X for a prepaid amount of time (e.g., a day, a week, a month, etc.). Accordingly, the model platform 103 may utilize the user model associated with Celebrity X to generate the desired recommendations for the user. In this case, because the recommendations are based on the celebrity's user model, the recommendations may be dynamic. That is, the recommendations may change as the celebrity's user model is dynamically updated, for instance, based on the celebrity's user interactions, ratings, context information, etc. Consequently, such recommendation services may be able to offer the user the opportunity to live the life of Celebrity X in real-time.

In another embodiment, the model platform 103 may cause sharing of the at least one user model to one or more other users. In one scenario, a celebrity such as Celebrity X may share the celebrity's user model through the paid service in the manner previously described. In another scenario, other users may wish to offer their user models to their family members, friends, peers, business associates, etc. As an example, a user associated with the name, Steve, has a birthday coming up. To prevent his friends and family members from giving him an unwanted birthday gift, Steve may share his user model to his friends and family members prior to his birthday. For instance, Steve may share his user model via peer-to-peer connection, through a social network, or through another service. In this way, his friends and family members can be provided with gift recommendations for him. In a further scenario, one of Steve's friends has already purchased a gift based on a recommendation previously generated based on Steve's shared user model. However, because Steve has an ever-changing lifestyle, the purchased gift is no longer an item that Steve wants. As a result, the model platform 103 may automatically detect this change based on an updated user model associated with Steve. Through the friend's user device, the model platform 103 may indicate to the friend that Steve no longer wants the purchased item and then recommend to the friend a new gift for Steve.

In another embodiment, the model platform 103 may cause a collection of user interaction data, ratings data, context data, etc., related to one or more items, at least one user of the device, and/or one or more other users. The user interaction data may, for instance, include data about how the user interacts with the device (e.g., UE 101). The user interaction data may also include the user's interaction with another device or external services (e.g., the services 117). The ratings data may include user ratings of the items indicating how much the user likes the items (e.g. collected via like/dislike buttons for corresponding items). The context data may include the sensor data, a user schedule, etc. The model platform 103 may then process and/or facilitate a processing of the collection to generate the at least one user model. As mentioned, for a number of reasons, the at least one user model may be generated on the device.

In another embodiment, the model platform 103 may determine user interaction data, ratings data, context data, etc., associated with the device and/or at least one user of the device. The model platform 103 may then update the at least one user model based on the user interaction data, the ratings data, the context data, etc. As discussed, user preferences and behavior may constantly change. Consequently, the at least one user model must be updated to maintain personalization, for instance, of recommendations for the at least one user. By way of example, the device (e.g., UE 101) can continue to determine data, such as user interaction data, ratings data, context data, etc. For example, the model platform 103 may detect that the at least one user has installed a new capability (e.g., Bluetooth, near field communication (NFC), etc.), a new application, etc. The model platform 103 may further determine that the at least one user has utilized the new capabilities (e.g., using NFC capabilities to purchase products). The determined data at the device may then be processed to generate a temporary user model for the device. The at least one user model may then be updated by supplementing the at least one user model with data from the temporary user model.

In another embodiment, the model platform 103 may cause a transfer of the at least one updated user model to the recommendation service, wherein the transfer is based on a triggering condition. In one scenario, the at least one updated user model may be transferred to the recommendation service when the user logs onto an online portal associated with the recommendation service. In this example, the update transfer operation may be skipped if the previous login is too recent (e.g., less than a day, less than a week, etc.). In another scenario, the update transfer operation may occur when the model platform 103 detects that the version of the user model on the device is substantially different from the version of the user model on stored via the recommendation service. In a further scenario, the update transfer operation may occur when the model platform 103 determines a new application, a new capability, a new item, new context data, etc. For example, upon the installation of new NFC capabilities, the model platform 103 may want to automatically generate an updated user model on the device and immediately transfer the updated user model to the recommendation service so that the user may be provided with locations offering NFC-related services.

In another embodiment, the model platform 103 may process and/or facilitate a processing the at least one user model and/or one or more other user models to generate one or more typical user models for one or more user segments. The model platform 103 may then process and/or facilitate a processing of the one or more typical user models to generate one or more recommendations for the one or more user segments. A recommendation system, for instance, may be able to obtain a sufficient understanding with respect to the preferences and behavior of its users by analyzing the many user models stored in its database (e.g., the model database 111), especially if there is enough data to analyze. As such, the recommendation system may be able to profile the overall customer base as to enable the recommendation system to identify emerging trends, identify differences in different geographical regions, design well-targeted marketing campaigns, etc., to create or modify these user segments. Moreover, recommendations may be generated for users based on the user segments in which the users fall. Consumers may, for instance, be mapped to a user segment by calculating the distance of their personal user model to the pre-calculated segment user models.

By way of example, the UE 101, the model platform 103, the service platform 115, and the content providers 119 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

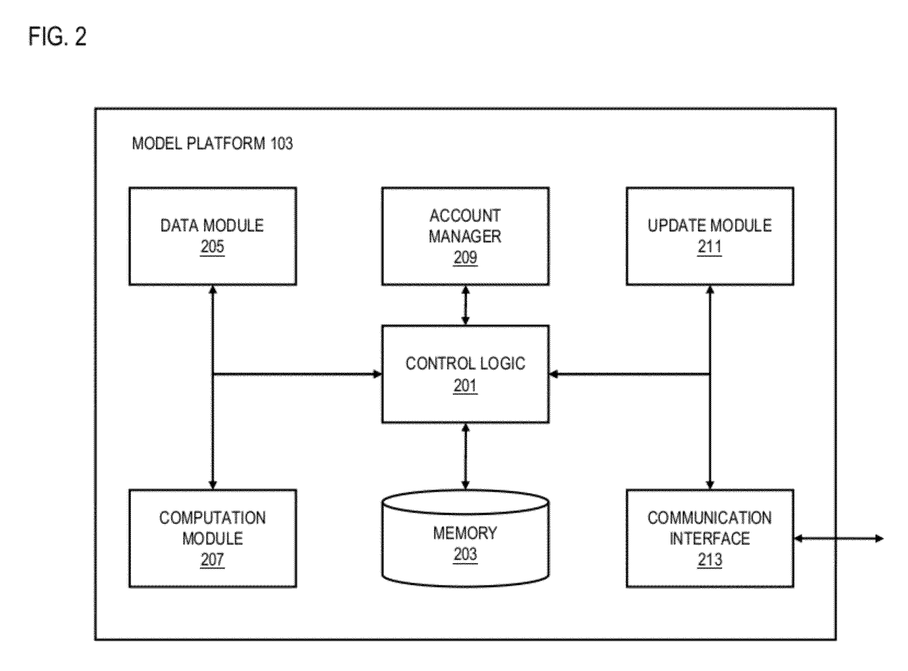

FIG. 2 is a diagram of the components of a model platform, according to one embodiment. By way of example, the model platform 103 includes one or more components for providing recommendations based on locally generated models. It is contemplated that the functions of these components may be combined in one or more components or performed by other components of equivalent functionality. In this embodiment, the model platform 103 includes control logic 201, memory 203, a data module 205, a computation module 207, an account manager 209, an update module 211, and a communication interface 213.

The control logic 201 executes at least one algorithm for executing functions of the model platform 103. For example, the control logic 201 may interact with the data module 205 to cause collection of data including user interaction data, ratings data, context data, or a combination thereof, wherein this data is related to items, a user of the device, other users, or a combination thereof. For example, the data module 205 may cause one or more of the UEs 101 to collect the data. The user interaction data may include data about the user's interaction within the user device (internal usage) as well as data about the user's interaction with external devices or services (external usage). The ratings data may include ratings assigned for the items. For example, a user may be requested to provide ratings for the items, and the user's ratings of the items may be maintained as the ratings data. The context data may include sensor data collected from a sensor such as a location sensor, speed sensor, sound sensor, etc., as well as a calendar, user profile information, etc.

The computation module 207 may then facilitate a processing of the collection, for instance, by working with the recommendation application 107 of the UE 101 to generate the user model. A user model generation engine in the recommendation application 107 (or in the computation module 207) may be capable of converting the collected data into a user model having quantitative values for the corresponding items. For example, the user model generation engine may be able to extract quantitative data such as the frequency of usage of each software application, the frequency of the user visiting a library (measured by the location sensor), a frequency of the user visiting the social networking website, etc., based on the collected data, and then generate the user model based on the quantitative data.

The control logic 201 may also utilize the communication interface 213 to communicate with other components of the model platform 103, the UEs 101, the service platform 115, the content providers 119, and other components of the system 100. By way of example, the communication interface 213 may assist in initiating the transfer of the user model, updates, etc., to one of the services 117 (e.g., the recommendation service). The communication interface 213 may further include multiple means of communication. In one use case, the communication interface 213 may be able to communicate over SMS, internet protocol, instant messaging, voice sessions (e.g., via a phone network), or other types of communication.

Following the transfer of the user model, for instance, the control logic 201 may instruct the account manager 209 to store the user model in the model database 111 and associate the user model with user profile information in the profile database 113. Moreover, the account manager 209 may also manage accounts associated with users of the system 100 along as well as accounts of the individual services 117. For example, the account manager 209 may link multiple devices belonging to a single user to that user's account. In one embodiment, the account manager 209 may further utilize user models from the multiple devices to generate recommendations for the user.

In addition, the control logic 201 may work with the update module 211 to monitor the occurrence of particular conditions (e.g., triggering conditions). In one scenario, for instance, the update module 211 may cause a transfer of an updated user model when the user logs onto a particular service. As mentioned, the update transfer operation may be skipped if the previous login is too recent, or if the changes in the updated user model is detected as insignificant (e.g., to preserve device and/or network resources).

Further, the computation module 207 may be utilized to generate recommendations based on user models in the model database 111 and user profile information in the profile database 113. As discussed, the user models may include user profile vectors. As an example, the recommendations may be based on the combination of the user profile vectors and the user profile information (e.g., ratings information). In this example, a matrix factorization approach may be used. To illustrate the expressions and/or functions associated with such approach, the following notations will be used:
i: index for items (1≦i≦M)
u: index for users (1≦u≦N)
vᵤ: UPV of user u
rᵤᵢ: rating given to item i by user u
R: the full rating matrix

The objective of the matrix factorization method is to express the rating matrix R (of dimension N×M) as the product of two smaller matrices P and Q of smaller dimension N×f and M×f respectively, where f is a parameter that must be chosen according to the amount of available data. Here, since the user profile vectors provide data in addition to the user profile information, the following adaptation of matrix A of dimension f×g may be introduced, where g is the dimension of the user profile vectors. The estimated ratings are expressed as:

\hat{r}ᵤᵢ=μ+bᵢ+bᵤ+qᵢ^{T}(pᵤ+Avᵤ)

where μ, bᵢ, bᵤ are biases and p,q are elements of P,Q. As usual, the values of all these additional variables and vectors are optimized in order to minimize the squared prediction error on the ratings that are available:

$${min}_{P , Q , μ , b , A} {\sum }_{i , u} ( {r}_{ui} - {\hat{r}}_{ui} ) + λ ( {‖ {p}_{u} ‖}^{2} + {‖ {q}_{i} ‖}^{2} )$$

where λ is the regularization parameter.

The above optimization problem may be verified to have the desired property such that if a user has given no rating yet, the optimal vector pᵤ for this user will be null (because of the regularization constraint). This however will not lead to a zero estimate of the ratings for this user, thanks to the term Avᵤ which will not be null.

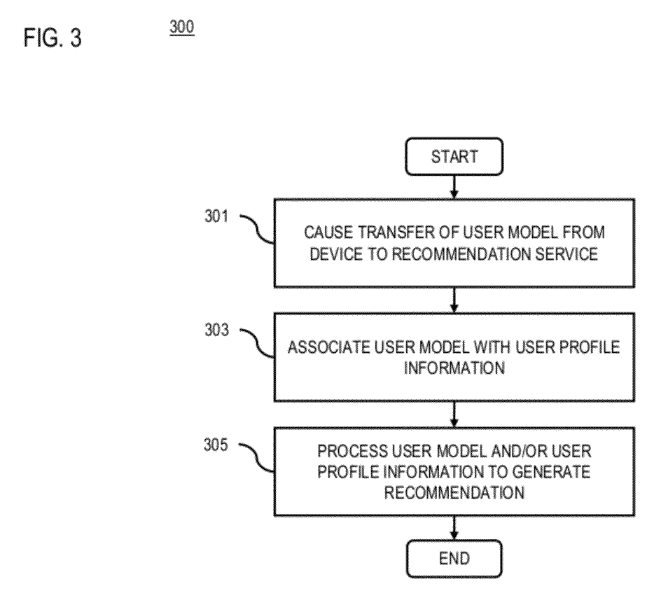

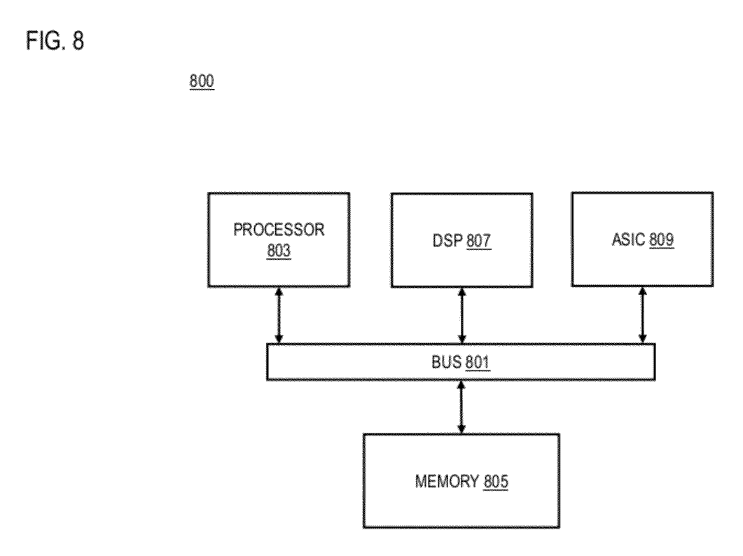

FIG. 3 is a flowchart of a process for providing recommendations based on locally generated models, according to one embodiment. In one embodiment, the control logic 201 and/or other components of the model platform 103 performs the process 300 and is implemented in, for instance, a chip set including a processor and a memory as shown in FIG. 8. As such, the control logic 201 can provide means for accomplishing various parts of the process 300 as well as means for accomplishing other processes in conjunction with other components of the model platform 103.

In step 301, the control logic 201 may cause a transfer of at least one user model from a device to a recommendation service, wherein the at least one user model is generated on the device. As discussed, the generation of the at least one user model on the device may preserve privacy in the sense that the behavioral data can be process without having to transmit such data to any external device or service. Because the behavioral data may be processed on the device to generate the at least one user model with latent variables (e.g., where a user profile vector is used), the discovery of confidential and/or personal information through reverse-engineering of the at least one user model may be prevented.

In step 303, the control logic 201 may associate the at least one user model with user profile information. By way of example, the at least one user model may represent device usage information (e.g., user interactions related to the device, ratings provided via the device, context history of the device, etc.) associated with at least one user of the device, while the user profile information may represent online usage information (e.g., user interactions with the recommendation service, ratings provided by the at least one user while using the recommendation service, etc.). In this way, the device usage information may supplement any missing online usage information to generate recommendations, for instance, for the at least one user. As such, in step 305, the control logic 201 may process and/or facilitate a processing of the at least one user model, the user profile information, or a combination thereof to generate at least one recommendation. In one scenario, a user may have a history of playing media files on the user's device, including songs, video clips, movies, etc. Thus, a user model may have been generated on the device based on interaction with the media files or related applications, ratings given to the media files, etc., by the user. When the user uses a particular music service for the first time, the music service may not have any useful usage information associated with the user. As such, the user model from the device may be transferred to the music service to supplement the music service's lack of usage information. Accordingly, the music service will thereafter provide recommendations to the user based on the user model and/or user profile information that it may have (e.g., the user's initial preferences selected when the user registered for the service).

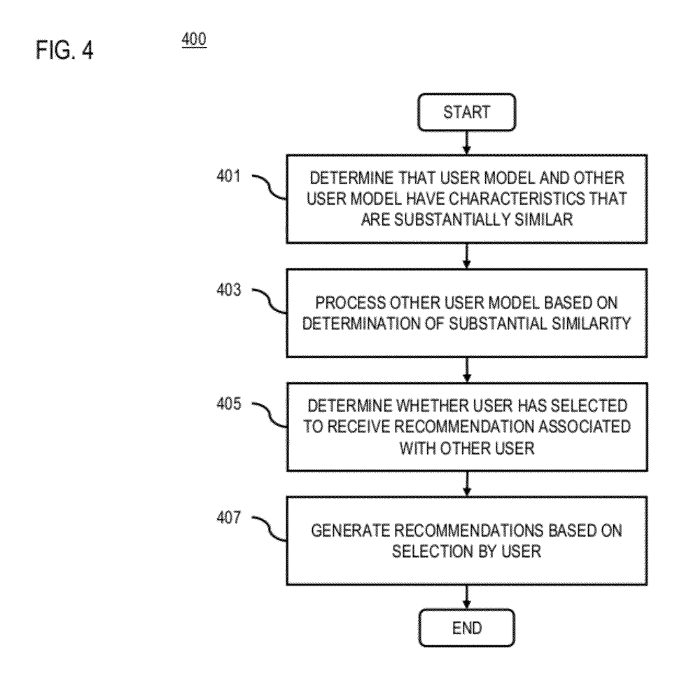

FIG. 4 is a flowchart of a process for generating recommendations using other user models and/or other item models, according to one embodiment. In one embodiment, the control logic 201 and/or other components of the model platform 103 performs the process 400 and is implemented in, for instance, a chip set including a processor and a memory as shown in FIG. 8. As such, the control logic 201 can provide means for accomplishing various parts of the process 400 as well as means for accomplishing other processes in conjunction with other components of the model platform 103.

In step 401, the control logic 201 may determine that the at least one user model and one or more other user models have one or more characteristics that are substantially similar. In one sample use case, the at least one user model may be associated with at least one user of the device and the one or more other user models may be associated with one or more other users. As explained, the respective user models may have characteristics that are substantially similar because the respective user models may have been generated based on similar usage history and similar user behavior to particular circumstances (e.g., similar lifestyles, interactions, etc.). In another use case, the at least one user model and the one or more other user models may be associated with the at least one user. As an example, the at least one user may have multiple devices, each of which has generated and transferred their respective user models to the recommendation service. In this case, the respective user models are likely to (but may not necessarily) have substantially similar characteristics because the respective user models all reflect the user's histories, behavior, etc.

In either case, the control logic 201 may, as in step 403, process and/or facilitate a processing of the one or more other user models based, at least in part, on the determination of substantial similarity. The processing of the one or more other user models may, for instance, later be utilized to further generate the at least one recommendation. In this way, if needed, data from the one or more other user models may be used to supplement information that may be lacking in the at least one user model and/or the user profile information. As such, better recommendations may be provided.

The control logic 201 may, as in step 405, also determine whether at least one user of the device has selected to receive recommendations associated with one or more other users. As mentioned, users may want to want to receive recommendations originally intended for other users for a number of reasons. As an example, a particular user may want to receive recommendations initially intended for another user so that the user can purchase a birthday gift that the other user would actually want and still retain the element of surprise. As another example, a user may also want to live the aspiration life of another user or the user may simply want to try new things, obtain new tastes, etc.

As such, the control logic 201 may, as in step 407, further generate at least one recommendation based, at least in part, on the determination of the selection by the at least one user. Thus, if it is determined that a particular user has selected to receive recommendations associated with another user (e.g., Celebrity X), the recommendations generated for the user may be based on a user model associated with the other user (rather than based on the user model associated with the user). On the other hand, if it is determined that the user has not selected to receive recommendations initially intended for another user, the recommendations generated for the user may be based on the user model associated with the user and/or user models determined to have characteristics substantially similar to the user model associated with the user.

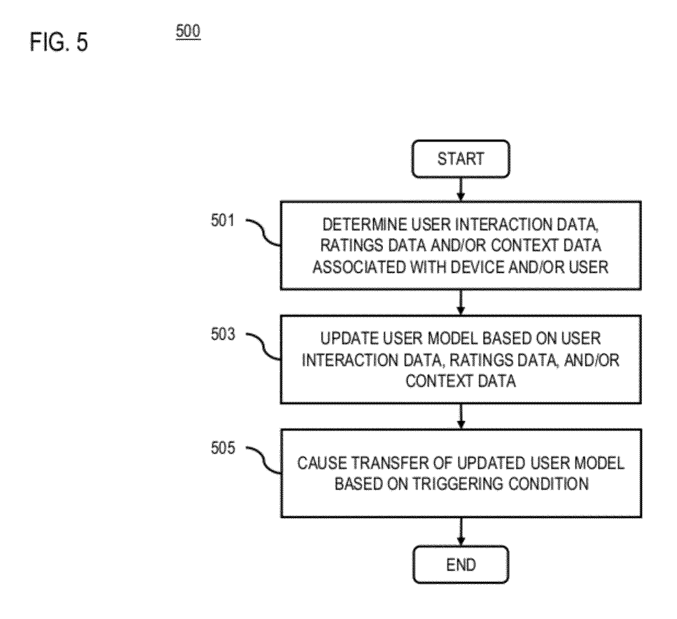

FIG. 5 is a flowchart of a process for updating a user model and/or an item model, according to one embodiment. In one embodiment, the control logic 201 and/or other components of the model platform 103 performs the process 500 and is implemented in, for instance, a chip set including a processor and a memory as shown in FIG. 8. As such, the control logic 201 can provide means for accomplishing various parts of the process 500 as well as means for accomplishing other processes in conjunction with other components of the model platform 103.

In step 501, the control logic 201 may determine user interaction data, ratings data, context data, or a combination thereof associated with the device, at least one user of the device, etc. The control logic 201 may, as in step 503, then update the at least one user model based on the user interaction data, the ratings data, the context data, etc. As such, the at least one user model may continue to reflect the current preferences and behaviors of the at least one user. In this way, the recommendations generated for the at least one user may continue to be personalized based on the most up-to-date information. In one scenario, it may be determined that a particular user has installed a new NFC capability on the device. Moreover, it may also be determined that the user has utilized the NFC capability to receive content (e.g., media files) from other users and that the user has frequency opened/activated the content since receiving the content. In this case, a user model on device may be updated to reflect the user's new interactions with the NFC capabilities and the content as well as implicit ratings received from the user's opening/activation of the content.

In step 505, the control logic 201 may further cause a transfer of the at least one updated user model to the recommendation service based on a triggering condition. In the previous example, the triggering condition may, for instance, have been the installation of the new NFC capability. In this way, the recommendation service may be able to immediately provide recommendations reflecting the new capability (e.g., local stores that accept NFC payment methods) upon the installation of the new capability. That is, the recommendation service would immediately be able to personalize its service more towards the at least one user of the device.

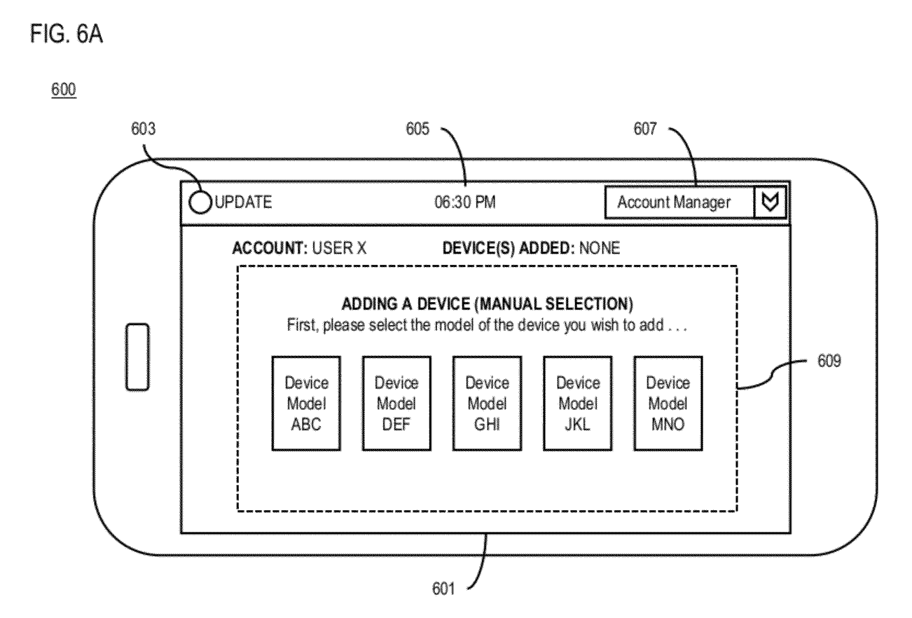

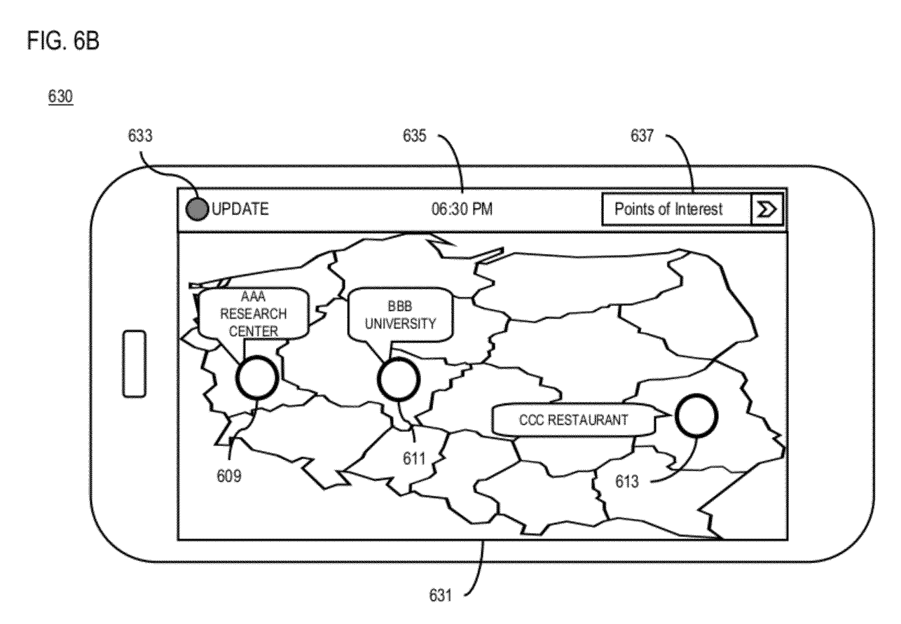

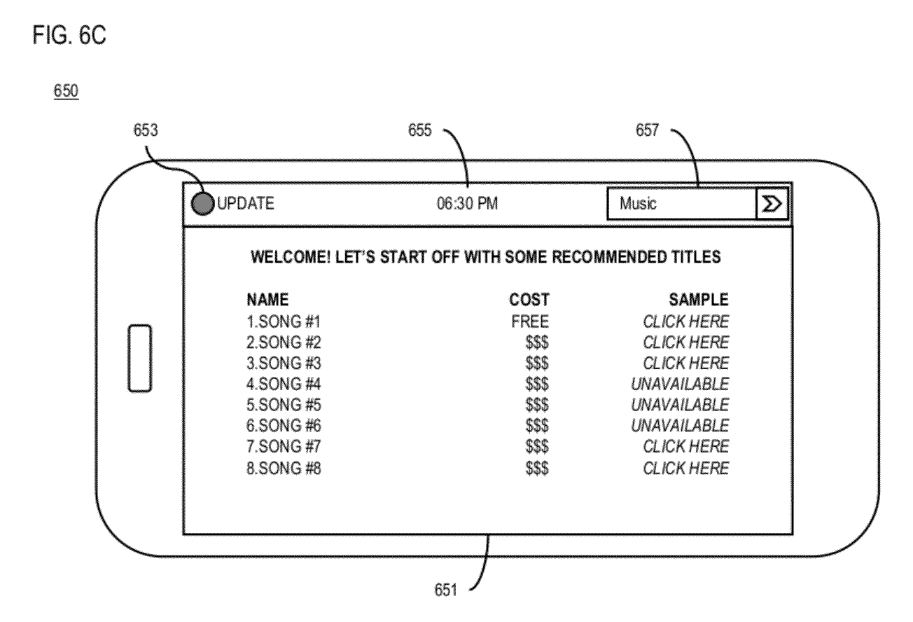

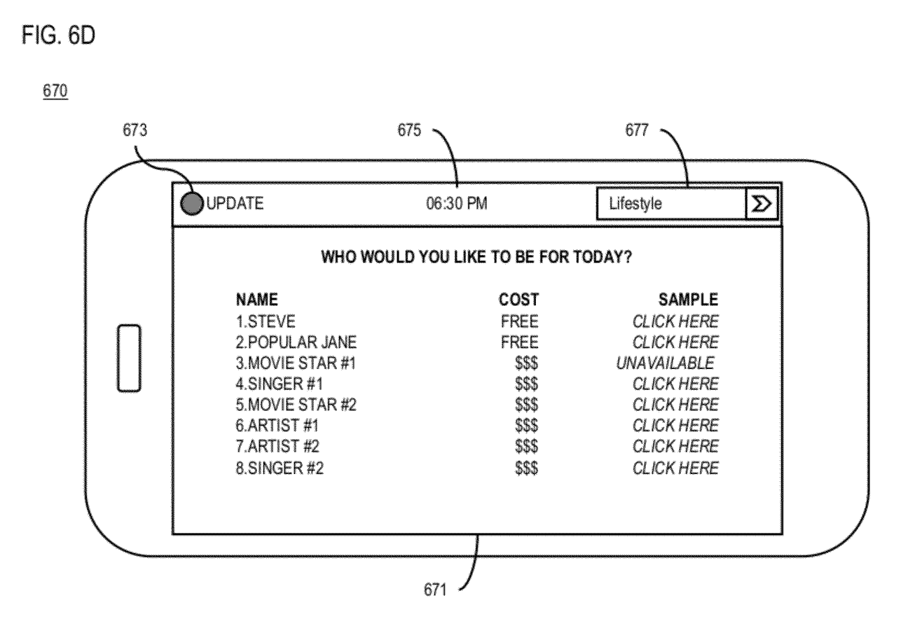

FIGS. 6A-6D are diagrams of user interfaces utilized in the processes of FIG. 3, according to various embodiments. FIG. 6A illustrates a user interface 600 that features a display 601, an update status 603, a clock 605, a box 607, and a prompt 609. As shown, a user (e.g., User X) has registered or is registering with an online portal. At the moment, the user is in an account manager section of the online portal as demonstrated by the box 607, which is currently a drop-down selection box. The display 601 indicates that the account belongs to User X and that User X has not registered any device with the online portal. The update status 603 is not filled in and, thus, may be telling the user that no user model updates are currently available. For example, because no devices have been added to the account, the online portal has not associated any transferred user models from any device. Here, it appears that the user has selected to manually add a device. In this way, the user may be able to log onto the online portal with any device without having to associate such device with the account. Moreover, this feature allows the user to add other devices associated with the user to the account such that the user models of those other devices may, for instance, be utilized to generate recommendations for the user.

FIG. 6B illustrates a user interface 630 that features a display 631, an update status 633, a clock 635, and a box 637. As shown, the update status 633 is filled in, demonstrating to the user that an update to the user model associated with the device is available. In this example, the user is searching for points of interest (POI) (e.g., box 637) in a city with which the user has not had any interactions with in the past. It may also be possible that the other users in the city may have never visited the user's hometown. Here, the user model that was generated on the user's device indicates that the user is a professor, or perhaps a specific type of professor. Because the recommendation service has a copy of the user model, it can compare the user model with other user models in its database. As explained, the recommendation service may look for other user models that have characteristics substantially similar to the user model associated with the user. When at least some such user models are identified, they may be utilized by the recommendation service along with the user model and user profile information of the user to generate recommendations. Also, because the user has the characteristics of a typical professor, the recommendation service may also utilize a typical user model that was previously generated for the professor user segment to generate recommendations for the user.

In FIG. 6B, AAA Research Center, BBB University, and CCC Restaurant was recommended to the user. By way of example, the research center and the university recommendations may have been based on the typical user model for the professor user segment while the restaurant recommendation may have been based on the other identified user models (e.g., similar lifestyle, tastes, etc., as the user). It is noted that the user interface 630 may have been customized for the user based on the user model and user profile information associated with the user (e.g., the box 637 is a search box rather than the drop-down box in FIG. 6A as a result of adding a device, the time format, the number of recommendations to show, etc.) whereas the recommended content is customized for the user using the identified user models and/or the typical user model. As discussed, the recommendations are not necessarily based on content analysis of what was recommended, but instead based on usage history and user behavior with respect to particular circumstances.

FIG. 6C illustrates a user interface 650 that features a display 651, an update status 653, a clock 655, and a box 657. As shown, the update status 653 is filled in, demonstrating to the user that an update to the user model associated with the device is available. In this example, the user is interacting with a music service (e.g., box 657). As previously discussed, it may not matter that the user has never used the particular music service before. The music service may, for instance, be associated with an online portal and may therefore personalize the experience for the user based on a user model that was generated on the device and transferred to the online portal (e.g., the recommendation service). Moreover, if it is determined that the user model is not enough (even with the user profile information), the user experience and the recommendations may further be based on other user models that are determined to have characteristics substantially similar to that of the user model of the user.

FIG. 6D illustrates a user interface 670 that features a display 671, an update status 673, a clock 675, and a box 677. As shown, the update status 673 is filled in, demonstrating to the user that an update to the user model associated with the device is available. In this example, the user is interacting with a “lifestyle” service, which may enable users to share their user models or to receive recommendations originally intended for other users based on user models associated with these other users. Here, for instance, the user may obtain recommendations intended for Steve and Popular Jane for free. These users, Steve and Popular Jane, may have decided to share their user models in order to help their friends and family members purchase items for them (e.g., gifts, necessities, etc.). In this way, their friends and family members can view recommendations originally intended for either Steve or Popular Jane. Popular Jane's parents, for instance, may be able to buy clothes and accessories for her without worrying that she will not like the purchased items. Moreover, in this case, other users may want to share their user models to make money. As illustrated, the user must pay in order to receive recommendations originally intended for Movie Star #1, Singer #1, Movie Star #2, Artist #1, Artist #2, and Singer #2. In return, the user will be able to live the life of these celebrities for the paid period. The celebrities, in exchange, may get some of the proceeds from the sale. As discussed, because the recommendations are generated based on the celebrities' user models, the recommendations may actually enable purchasing users to “live” the celebrities' lives as the user models can be frequently updated—mimicking or allowing real-time updates.

The processes described herein for providing recommendations based on locally generated models may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

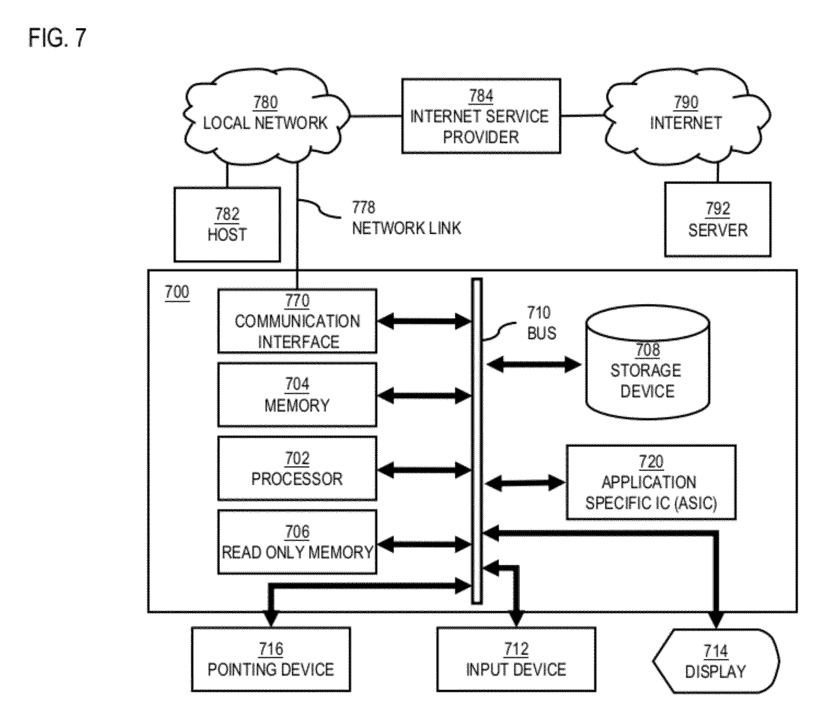

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide recommendations based on locally generated models as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing recommendations based on locally generated models.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to providing recommendations based on locally generated models. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for providing recommendations based on locally generated models. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing recommendations based on locally generated models, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for providing recommendations based on locally generated models to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide recommendations based on locally generated models as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of providing recommendations based on locally generated models.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide recommendations based on locally generated models. The memory 805 also stores the data associated with or generated by the execution of the inventive steps.

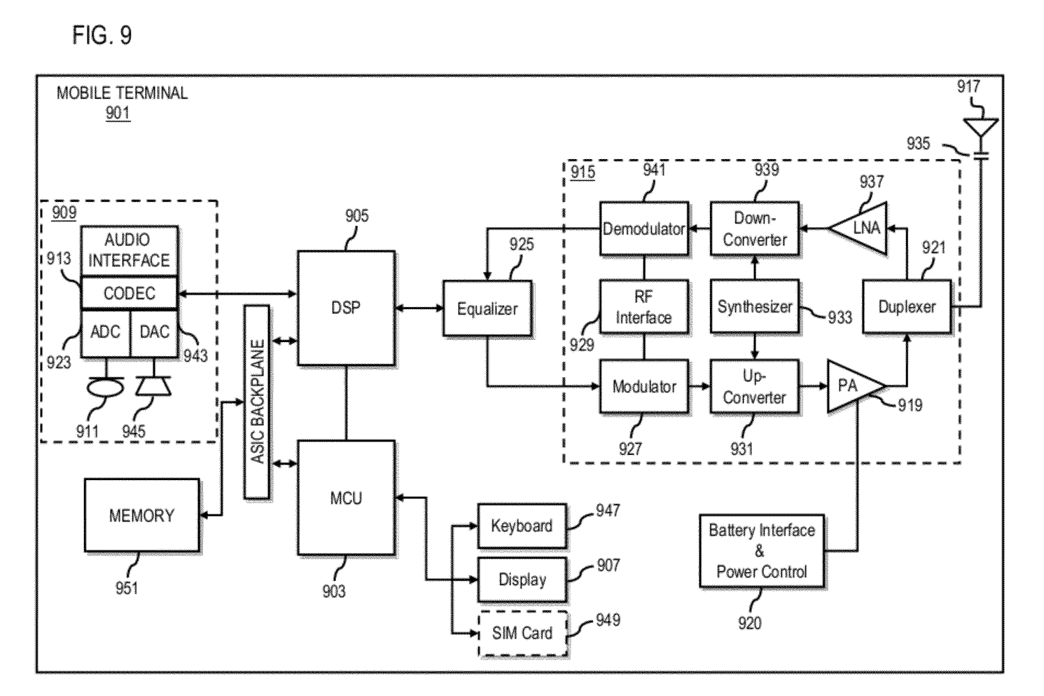

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of providing recommendations based on locally generated models. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing recommendations based on locally generated models. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide recommendations based on locally generated models. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a transfer of at least one user model from a device to a recommendation service, wherein the at least one user model is generated on the device;
at least one determination to associate the at least one user model with user profile information; and
a processing of the at least one user model, the user profile information, or a combination thereof to generate at least one recommendation.

2. A method of claim 1, wherein the (1) data and/or (2) information and/or (3) at least one signal are further based, at least in part, on the following:
at least one determination that the at least one user model and one or more other user models have one or more characteristics that are substantially similar;
a processing of the one or more other user models based, at least in part, on the determination of substantial similarity,
wherein the at least one recommendation is further generated based, at least in part, on the processing of the one or more other user models.

3. A method of claim 2, wherein the at least one user model is associated with at least one user of the device and the one or more other user models are associated with one or more other users.

4. A method of claim 1, wherein the (1) data and/or (2) information and/or (3) at least one signal are further based, at least in part, on the following:
at least one determination of whether at least one user of the device has selected to receive recommendations associated one or more other users,
wherein the at least one recommendation is further generated based, at least in part, on the determination of the selection by the at least one user.

5. A method of claim 1, wherein the (1) data and/or (2) information and/or (3) at least one signal are further based, at least in part, on the following:
a sharing of the at least one user model to one or more other users.

6. A method of claim 1, wherein the (1) data and/or (2) information and/or (3) at least one signal are further based, at least in part, on the following:
a collection of user interaction data, ratings data, context data, or a combination thereof related to: (a) one or more items, (b) at least one user of the device, (c) one or more other users, or (d) a combination thereof; and
a processing of the collection to generate the at least one user model.

7. A method of claim 1, wherein the (1) data and/or (2) information and/or (3) at least one signal are further based, at least in part, on the following:
at least one determination of user interaction data, ratings data, context data, or a combination thereof associated with the device, at least one user of the device, or a combination thereof; and
at least one determination to update the at least one user model based, at least in part, on the user interaction data, the ratings data, the context data, or a combination thereof.

8. A method of claim 7, wherein the (1) data and/or (2) information and/or (3) at least one signal are further based, at least in part, on the following:
a transfer of the at least one updated user model to the recommendation service based, at least in part, on a triggering condition.

9. A method of claim 1, wherein the (1) data and/or (2) information and/or (3) at least one signal are further based, at least in part, on the following:
a processing the at least one user model, one or more other user models, or a combination thereof to generate one or more typical user models for one or more user segments; and
processing and/or facilitating a processing of the one or more typical user models to generate one or more recommendations for the one or more user segments.

10. A method of claim 1, wherein the at least one user model includes at least one user profile vector, at least one item profile vector, or a combination thereof, and wherein the at least one recommendation is generated based, at least in part, on the least one user profile vector, the at least one item profile vector, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, a transfer of at least one user model from a device to a recommendation service, wherein the at least one user model is generated on the device;
determine to associate the at least one user model with user profile information; and
process and/or facilitate a processing of the at least one user model, the user profile information, or a combination thereof to generate at least one recommendation.

12. An apparatus of claim 11, wherein the apparatus is further caused to:
determine that the at least one user model and one or more other user models have one or more characteristics that are substantially similar;
process and/or facilitate a processing of the one or more other user models based, at least in part, on the determination of substantial similarity,
wherein the at least one recommendation is further generated based, at least in part, on the processing of the one or more other user models.

13. An apparatus of claim 12, wherein the at least one user model is associated with at least one user of the device and the one or more other user models are associated with one or more other users.

14. An apparatus of claim 11, wherein the apparatus is further caused to:
determine whether at least one user of the device has selected to receive recommendations associated one or more other users,
wherein the at least one recommendation is further generated based, at least in part, on the determination of the selection by the at least one user.

15. An apparatus of claim 11, wherein the apparatus is further caused to:
cause, at least in part, sharing of the at least one user model to one or more other users.

16. An apparatus of claim 11, further comprising:
cause, at least in part, collection of user interaction data, ratings data, context data, or a combination thereof related to: (a) one or more items, (b) at least one user of the device, (c) one or more other users, or (d) a combination thereof and
process and/or facilitate a processing of the collection to generate the at least one user model.

17. An apparatus of claim 11, wherein the apparatus is further caused to:
determine user interaction data, ratings data, context data, or a combination thereof associated with the device, at least one user of the device, or a combination thereof and
determine to update the at least one user model based, at least in part, on the user interaction data, the ratings data, the context data, or a combination thereof.

18. An apparatus of claim 17, wherein the apparatus is further caused to:
cause, at least in part, a transfer of the at least one updated user model to the recommendation service based, at least in part, on a triggering condition.

19. An apparatus of claim 11, wherein the apparatus is further caused to:
process and/or facilitate a processing the at least one user model, one or more other user models, or a combination thereof to generate one or more typical user models for one or more user segments; and
process and/or facilitate a processing of the one or more typical user models to generate one or more recommendations for the one or more user segments.

20. An apparatus of claim 11, wherein the at least one user model includes at least one user profile vector, at least one item profile vector, or a combination thereof, and wherein the at least one recommendation is generated based, at least in part, on the least one user profile vector, the at least one item profile vector, or a combination thereof.

21-48. (canceled)
